(19) United States
(12) Patent Application Publication
(10) Pub. No.: US 2016/0258799 A1
(43) Pub. Date: Sep. 8, 2016

(54) Method and device for recognizing an error in the acquisition of sensor quantities relating to a mass flow or to a pressure in a gas line system of an internal combustion engine

(71) Applicant: Robert Bosch GmbH, Stuttgart (DE)

(72) Inventors: Daniel Kuhn, Walddorfhaeslach (DE); Thomas Farr, Ludwigsburg (DE)

(21) Appl. No.: 15/053,908

(22) Filed: Feb. 25, 2016

(30) Foreign Application Priority Data
Mar. 3, 2015 (DE) 10 2015 203 794.0

(51) Int. Cl. G01F 1/88

(52) U.S. Cl. CPC G01F 1/88

(57) ABSTRACT

A method for recognizing an error in the acquisition of a pulsing sensor quantity of a sensor in a gas line system of an internal combustion engine includes: acquisition of a plurality of sensor values of the pulsing sensor quantity that represent a curve of the sensor quantity; determination of a deviation value that indicates a measure of a deviation of the pulsing sensor values from a mean value of the sensor quantity; and recognition of an error of the sensor as a function of the deviation value.

### BACKGROUND OF THE INVENTION

1. Field of the Invention

The present invention relates to internal combustion engines, and in particular to methods for recognizing errors in the acquisition of sensor quantities for measuring a mass flow or air in a gas line system of an internal combustion engine.

2. Description of the Related Art

In order to determine an operating state of an internal combustion engine, as a rule sensor quantities are measured that indicates state quantities of gas flows in the internal combustion engine. To conduct gas flows, the internal combustion engine has a gas line system; in particular, air is supplied to the internal combustion engine via an air supply system, and combustion exhaust gas is conducted away via an exhaust gas evacuation system. As state quantities, frequently the air mass flow of the supplied air, a charge or intake pipe pressure, or an exhaust gas counter-pressure is acquired using suitable mass flow or pressure sensors.

Legislation requires a plausibility test for such mass flow and pressure sensors relating to the gas line system.

Previous methods provide plausibilization of the sensor quantities acquired using the mass flow or pressure sensors through the use of redundant information, via physical models based on sensor signals of other sensors.

For this purpose, it is necessary for a particular operating point to be present or actively set. Thus, a pressure sensor in the intake pipe segment of the air supply system can for example be plausibilized using an environmental pressure sensor, as long as the internal combustion engine is switched off and an environmental pressure is thereby established also at the intake pipe pressure sensor in the intake pipe segment. In addition, an air mass sensor can be plausibilized using a reference mass flow model that can be applied only when the exhaust gas recirculation is deactivated. Frequently, in order to carry out the diagnosis the exhaust gas recirculation valve is closed even though in the momentary operating range an active exhaust gas recirculation would be better for the internal combustion engine.

If, however, a particular operating point is present or has to be actively set in order to make it possible to carry out the plausibilization of the sensor signal, then, under some circumstances, the error recognition via the diagnosis cannot take place until clearly after the occurrence of the error. In addition, errors may remain unrecognized that occur only in the operating range of the internal combustion engine and not at the operating point at which the check of the sensor signal is carried out. A further disadvantage is that conventional diagnosis methods standardly relate to stationary deviations between a sensor and a reference, so that a sensor error that has an effect only on the signal dynamic and does not result in a stationary deviation cannot be recognized.

It is therefore desirable to carry out a plausibilization of a sensor quantity of a mass flow sensor and/or of a pressure sensor in a gas line system in which a dynamic degradation or a failure of the sensor is carried out during regular operation of an engine system; i.e., without it being necessary to take particular operating states, or to wait until such an operating state is reached in the conventional operation of the engine system.

### BRIEF SUMMARY OF THE INVENTION

According to the present invention, a method is provided for recognizing an error in an acquisition of a sensor quantity of an air mass sensor and/or of a pressure sensor in a gas line system of an internal combustion engine, and a corresponding device and an engine system are provided.

According to a first aspect, a method is provided for recognizing an error in the acquisition of a pulsing sensor quantity of a sensor in a gas line system of an internal combustion engine, having the following steps:
acquisition of a plurality of sensor values of the pulsing sensor quality, representing a curve of the sensor quantity;
determination of a deviation value that indicates a measure of a deviation of the pulsing sensor values from a mean value of the sensor quantity;
recognition of an error of the sensor as a function of the deviation value.

The sensor signal of a mass flow sensor, or of a pressure sensor, in a gas line system of an internal combustion engine has, given a switched-on internal combustion engine, a pulsing curve in normal operation. The pulsation results from the stroke operation of the internal combustion engine, and is a function of the rotational speed of the internal combustion engine. Pulsations can be detected both in the air supply system, due to the cyclical suctioning of fresh air into the cylinders of the internal combustion engine, and also in the exhaust gas evacuation system, due to the cyclical ejection of combustion exhaust gas from the cylinders.

If a property of such a pulsation deviates from an expected property of the pulsation, then an error in the sensor system can be inferred. An idea of the above-indicated method is to continuously monitor a deviation value of the sensor signal that indicates a property of the pulsation for the presence of the above-indicated error types.

Through the monitoring of the deviation value, it is possible to detect a faulty acquisition of the sensor signal through the relevant sensor almost immediately at the time of the occurrence of the error. In addition, the diagnosis can be carried out in a signal range of the sensor signal in which the relevant sensor is used. In addition, in particular sensor errors can be recognized that have an effect only on the signal dynamic, and do not cause stationary deviations.

Because the sensor errors diagnosed using the above method standardly have direct effects on the reference values of regulators of the gas line system, sensor failures that are not timely recognized can result in damage to or failure of the engine system. Through the diagnosis corresponding to the above method, it is possible to timely recognize sensor failures that may be present, and, through corresponding counter-measures, to provide emergency operation or shutoff of the engine system.

In addition, the deviation value can correspond to a deviation of the maximum and minimum value of the sensor quantity within a segment time duration of the pulsing sensor quantity from a mean value of the sensor quantity, a variance of the sensor quantity, a standard deviation of the sensor quantity, or combinations of one or more of the above quantities.

It can be provided that the sensor quantity is indicated as pressure from a pressure sensor or as mass flow from a mass flow sensor.

In particular, a stuck-in-range error can be determined if an error condition is met according to which the deviation value has a value that essentially indicates no pulsation of the sensor quantity.

In addition, a slow-response error can be determined if an error condition is met according to which the deviation value does not deviate from a reference deviation value, or deviates from the reference deviation value by not more than a prespecified relative or absolute tolerance amount.

It can be provided that the stuck-in-range error or the slow-response error is recognized when the corresponding error condition is met for a prespecified time duration.

In addition, the recognition of an error can be carried out when an enable condition is met.

In particular, the enable condition can be met if
the deviation value exceeds a deviation threshold value, and/or
the rotational speed falls below a rotational speed threshold value, and/or
a low air system dynamic is present.

According to a further aspect, a device is present that is fashioned in order to carry out the above method.

### BRIEF DESCRIPTION OF THE DRAWINGS

FIG. 1 shows a schematic representation of an engine system having an internal combustion engine and a gas line system in which there are situated a mass flow sensor and a pressure sensor.

FIG. 2 shows a diagram illustrating a method for plausibilizing a sensor signal of a mass flow or pressure sensor situated in the gas line system.

FIG. 3 shows a curve of a sensor signal for an example of a mass flow sensor in the air supply system.

FIG. 4 shows a characteristic map for reading out an expected value for a sensor signal amplitude of a particular sensor signal as a function of an operating point of the internal combustion engine.

### DETAILED DESCRIPTION OF THE INVENTION

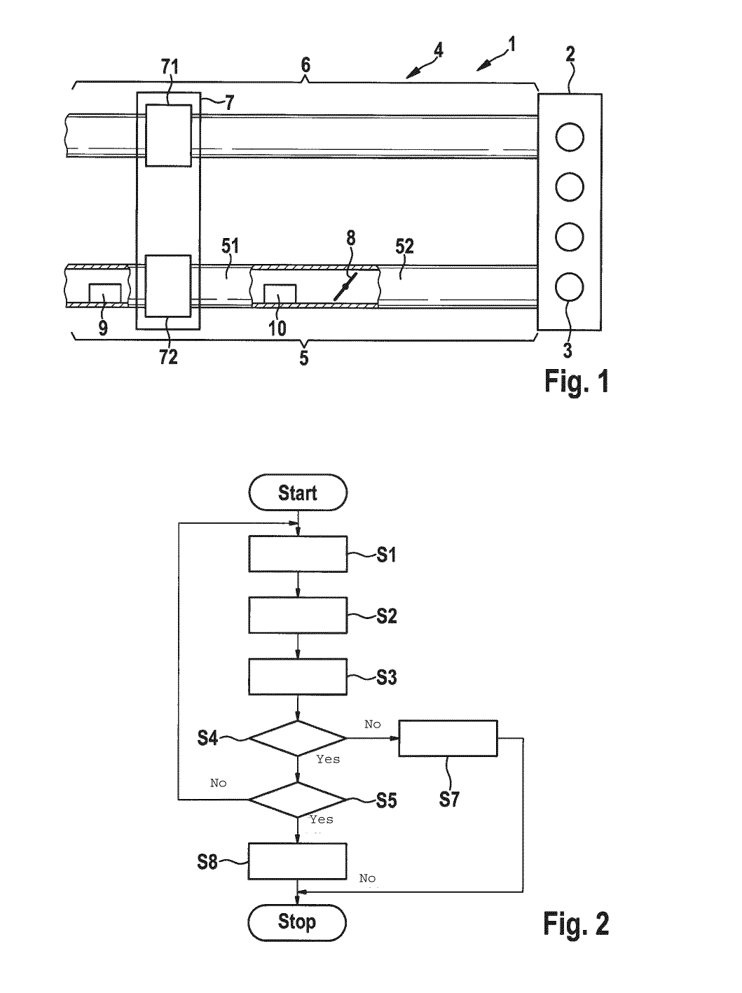

FIG. 1 shows a schematic representation of an engine system 1 having an internal combustion engine 2 that has a plurality of (in the present exemplary embodiment, four) cylinders 3. Internal combustion engine 2 can be fashioned as a spark-ignition engine or as a diesel engine, and is operated according to a four-stroke or some other stroke-based method. Internal combustion engine 2 is connected to a gas line system 4 that has an air supply system 50 for supplying fresh air to the cylinders 3 of internal combustion engine 2, and an exhaust gas evacuation system 6 for carrying off combustion exhaust gas from the internal combustion engine 3.

Gas line system 4 can be coupled to an exhaust gas-driven charger device 7. The charger device 7 converts the exhaust gas enthalpy contained in the combustion exhaust gas in exhaust gas evacuation segment 6 into mechanical energy, using a turbine 71, and uses this to operate a compressor 72 that is situated in air supply system 5. Compressor 72 draws in environmental air and compresses it in a charge pressure segment 51 of air supply system 5.

In addition, in air supply system 5 there is situated a throttle valve 8 that separates charge pressure segment 51 from an intake pipe segment 52 situated downstream therefrom. In gas line system 4 there can be provided one or more mass flow sensors, or one or more pressure sensors, for acquiring operating state quantities. For example, a mass flow sensor 9 can be situated at the input side of compressor 72, in order to detect an air mass flow supplied to internal combustion engine 2 and to provide a corresponding mass flow indication. In addition, in charge pressure segment 51 and/or in intake pipe segment 52 there can be provided a pressure sensor 10 in order to acquire a corresponding indication concerning a charge pressure or intake pipe pressure.

Cylinders 3 of internal combustion engine 2 are provided in a known manner with inlet and outlet valves (not shown), in order to admit fresh air into cylinders 3 and to eject combustion exhaust gas from cylinders 3 in accordance with a stroke operation of the internal combustion engine. During operation of internal combustion engines, this stroke operation causes an oscillating gas column in air supply system 54 in exhaust gas evacuation 6, which is a function of the rotational speed of the internal combustion engine 2. The resulting pulsations in air supply system 5 and in exhaust gas evacuation system 6 are always present during operation of internal combustion engine 2, the pulsation amplitudes of the pulsing pressure, or of the pulsing mass flow in gas line system 4, 5, being a function of the operating point of the internal combustion engine, in particular its rotational speed and load. The pulsations in gas line system 4 represent a disturbance to the regulation of air supply system 5 or exhaust gas evacuation system 6, such as the AGR regulation, the charge pressure regulation, and the like.

The sensor signals of mass flow sensor 9 or of pressure sensor 10 correspondingly have a pulsation portion in the sensor signal that is eliminated through suitable filter designs for the use of the sensor quantity determined by the sensor signal. As a rule, the models and regulations based thereon use a mean value of the corresponding sensor quantity.

Pulsation frequency f of the oscillation of the pulsation portion can be derived directly from the engine rotational speed n (in RPM) and the cylinder number Z:

$$f = \frac{n}{60} \cdot \frac{Z}{2}$$

The segment length T_{segment} results as the reciprocal of the pulsation frequency f:

$${T}_{Segment} = \frac{60}{n} \cdot \frac{2}{Z}$$

Via the segment length T_{segment} or multiples thereof, as an example the mean value of the air mass flow \dot{m} as the sensor quantity can be calculated as

$$\overline{\dot{m}} = \frac{{\sum }_{j = 1}^{k} {\dot{m}}_{j}}{k}$$

where k corresponds to the number of evaluated sensor values during a segment length T_{segment}.

The pulsation amplitude r_{Puls} is calculated for each complete segment T_{segment} i.e. oscillation period:

$${r}_{Puls} = \frac{{\dot{m}}_{fmax} - {\dot{m}}_{fmin}}{\overline{\dot{m}} \cdot 2}$$

where \dot{m}_{ƒmax}, \dot{m}_{ƒmin} correspond respectively to a maximum and minimum sensor value of air mass flow \dot{m}.

Using the flow diagram of FIG. 2, a method is shown for recognizing an error in the acquisition of a sensor quantity for a sensor in gas line system 4, 5 of engine system 1. As an example, an air mass sensor is shown, which provides sensor values \dot{m} as sensor signal.

In step S1, for this purpose successive sensor values \dot{m} are acquired through sampling of the sensor signal, and in step S2 a mean value \overline{\dot{m}} of the sensor signal is determined corresponding to the above computing rules. From the mean value of the sensor signal, corresponding to the above equation the pulsation amplitude r_{Puls} is ascertained as a deviation value of the sensor quantity that describes a pulsation property of the sensor quantity.

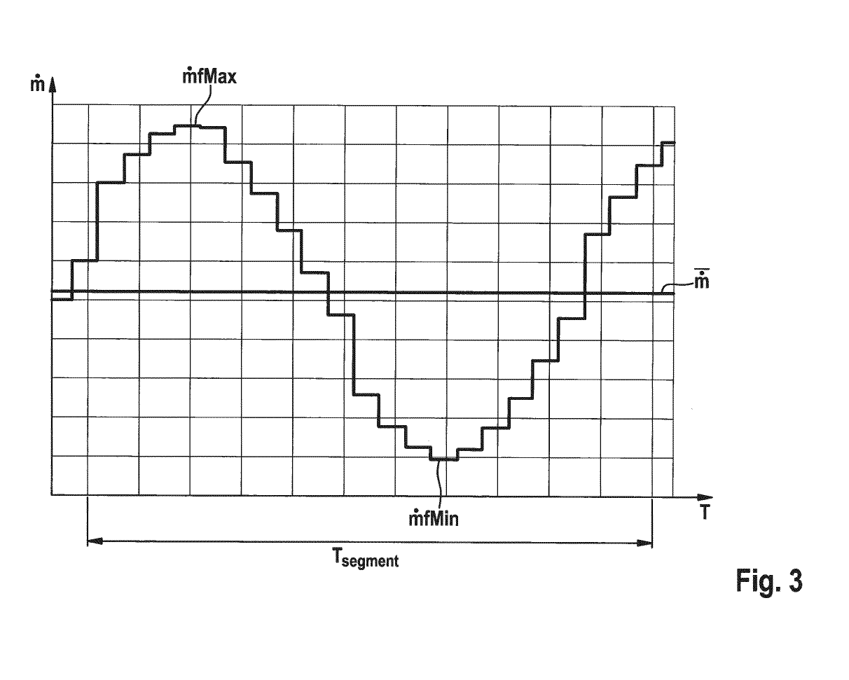

FIG. 3 schematically shows the curve of the sensor quantity \dot{m} and its mean value \overline{\dot{m}} and maximum and minimum value \dot{m}_{ƒmax}, \dot{m}_{ƒmin}.

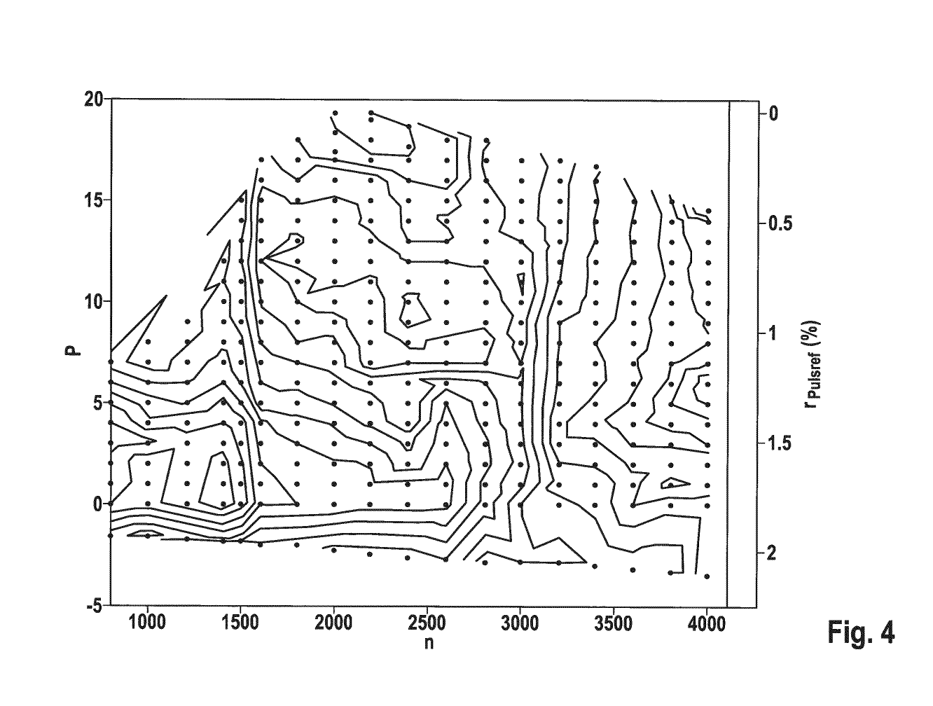

In step S3, in a characteristic map, as a function of a momentary operating point of internal combustion engine 2, for example as a function of a load quantity such as a torque, a cylinder pressure p, or the like, and/or as a function of rotational speed n, a reference pulsation amplitude r_{Pulsref} is ascertained as a relative indication reference deviation value for the momentary operating point. An example of such a characteristic map is shown in FIG. 4, where the lines are contour lines, and the regions between the contour lines indicate identical reference pulsation amplitudes.

In step S4 it is checked whether a magnitude of pulsation amplitude r_{Puls} is greater than a prespecified minimum value. If this is the case (alternative: yes), then the method continues with step S5. Otherwise (alternative: no), then in step S7 a stuck-in-range error is signaled. Because as a result of their design internal combustion engines have pulsations in gas line system 4, 5, a measurable pulsation amplitude should always be present when the internal combustion engine is switched on. If a stuck-in-range error is present, pulsation of the sensor quantity is no longer recognized. In particular, a stuck-in-range error can be recognized when the pulsation amplitude r_{Puls} is below the specified minimum value for a defined debounce time.

In step S5, reference pulsation amplitude r_{Pulsref} is compared to acquired pulsation amplitude r_{Puls}. If there is a deviation, in particular a deviation by more than a specified absolute or relative tolerance amount, then a faulty acquisition of the sensor quantity, and in particular a faulty sensor, in particular a faulty mass flow sensor 9 or pressure sensor 10, is inferred. If an error is detected (alternative: yes), then this slow-response error is signaled in step S8; otherwise (alternative: no) the method is cyclically repeated by jumping back to step S1.

A slow-response error designates an error type in which only the dynamic of the sensor quantity is degraded. The occurrence of such an error can cause degradation of drivability, of emissions functioning, of regulator stability, or of robustness.

Such a faulty dynamic degradation can be adopted as a low-pass characteristic. In order to take into account a relative tolerance range, reference pulsation amplitude r_{Pulsref} is multiplied by an attenuation that is a function of the rotational speed in order to obtain a minimum expected value for pulsation amplitude r_{Puls}. If pulsation amplitude r_{Puls} is below the expected value for a defined debounce time, a slow-response error is recognized and is correspondingly signaled.

In order to increase the robustness of the diagnostic function for the slow-response error, the diagnosis can be enabled during a particular operating range of the engine system. In particular, an enable condition can include the condition that the pulsation amplitude r_{Puls} exceeds a pulsation amplitude threshold value that indicates a pulsation amplitude that is significant for the diagnosis (for the recognition of a slow-response error), that the rotational speed falls below a rotational speed threshold value, and/or that a low air system dynamic is present.

Instead of pulsation amplitude r_{Puls}, other statistical features of the sensor signal can also be used that describe the deviation from a mean value, such as the variance of the sensor signal or the standard deviation of the sensor signal.

What is claimed is:

1. A method for recognizing an error in acquisition of a pulsing sensor quantity of a sensor in a gas line system of an internal combustion engine, comprising:
acquiring a plurality of sensor values of the pulsing sensor quantity representing a curve of the pulsing sensor quantity;
determining a deviation value indicating a measure of deviation of the pulsing sensor values from a mean value of the sensor quantity; and
recognizing an error of the sensor as a function of the determined deviation value.

2. The method as recited in claim 1, wherein the deviation value corresponds to a ratio between (i) a difference between the maximum and minimum values of the sensor quantity within at least one segment time duration of the pulsing sensor quantity, and (ii) one of a mean value of the sensor quantity, a variance of the sensor quantity, or a standard deviation of the sensor quantity.

3. The method as recited in claim 2, wherein the sensor quantity is one of a pressure quantity provided by a pressure sensor or a mass flow quantity provided by a mass flow sensor.

4. The method as recited in claim 2, wherein a stuck-in-range error is recognized if the deviation value indicates no pulsation of the sensor quantity.

5. The method as recited in claim 2, wherein a slow-response error is recognized if the deviation value does not deviate from a reference deviation value by more than a predetermined tolerance amount.

6. The method as recited in claim 4, wherein the stuck-in-range error is recognized if the deviation value indicates no pulsation of the sensor quantity for a predetermined time duration.

7. The method as recited in claim 5, wherein the slow-response error is recognized if the deviation value does not deviate from a reference deviation value by more than a predetermined tolerance amount for a predetermined time duration.

8. The method as recited in claim 2, wherein the recognition of an error is carried out only if an enable condition is met.

9. The method as recited in claim 7, wherein an error is recognized if at least one of: the deviation value exceeds a deviation threshold value; a rotational speed of the engine falls below a rotational speed threshold value; and an air system dynamic below a predefined minimum level is present.

10. A non-transitory, computer-readable data storage medium storing a computer program having program codes which, when executed on a computer, perform a method for recognizing an error in acquisition of a pulsing sensor quantity of a sensor in a gas line system of an internal combustion engine, the method comprising:
acquiring a plurality of sensor values of the pulsing sensor quantity representing a curve of the pulsing sensor quantity;
determining a deviation value indicating a measure of deviation of the pulsing sensor values from a mean value of the sensor quantity; and
recognizing an error of the sensor as a function of the determined deviation value.
